(19) United States
(12) Patent Application Publication
(10) Pub. No.: US 2026/0225653 A1
(43) Pub. Date: Aug. 6, 2026

(54) ROLLER ASSEMBLIES WITH SELECTIVELY PROTRUDING FINS

(71) Applicant: Heather Hender, Portland, OR (US)

(72) Inventor: Heather Hender, Portland, OR (US)

(21) Appl. No.: 19/575,709

(22) Filed: Mar. 23, 2026

Related U.S. Application Data
(63) Continuation-in-part of application No. 19/073,961, filed on Mar. 7, 2025, now Pat. No. 12,595,147.

(51) Int. Cl. B62D 11/00; B65G 39/02; B65H 23/04

(52) U.S. Cl. CPC B62D 11/001; B65G 39/02; B65H 23/048; B65H 2403/51; B65H 2404/12

(57) ABSTRACT

Roller assemblies including a tube wall, a control surface assembly, and a fin actuator. The tube wall defines an interior space, an exterior surface, and slots. The slots pass through the tube wall. The control surface assembly is within the interior space and includes fins aligned with the slots. The fins selectively move between a retracted position and an extended position. The fin actuator selectively moves the fins between the retracted position and the extended position. The fins include a control surface that contacts a target surface when the fins are selectively moved to protrude beyond the exterior surface. The control surfaces of the fins collectively define a circumferential control surface extending around the tube wall and contact a target surface from a plurality of radial positions around the tube wall. A control surface diameter exceeds an exterior surface diameter by a variable amount.

### CROSS-REFERENCE TO RELATED APPLICATIONS

This application claims priority to copending U.S. Application, Serial No. 19073961, filed on March 7, 2025, which is hereby incorporated by reference for all purposes.

### BACKGROUND

The present disclosure relates generally to rollers. In particular, roller assemblies with selectively protruding fins are described.

Rollers have a wide range of applications. One application for rollers is guiding webs. Another application for rollers is brushing surfaces, such as a brush roller in a vacuum cleaner. Many other applications for rollers exist as well.

Web guides are used in web processing machines (hereinafter web machines). Web guides are also used in web or belt conveyance systems. Conveyor belts used in warehouses, factories, farms, and job sites are examples of web conveyance systems that utilize web guides. Airports and shipping facilities also make extensive use of web conveyance systems and web guides to move packages and luggage efficiently.

Web machines manipulate webs of media in various ways. A printing press is one example of a web machine. A printing press moves a web of paper at high speed and prints information on the paper.

A wide variety of webs may be processed in web machines. For example, some web machines process battery separator film or polyethylene terephthalate (PET) film. Web machines are also utilized to manufacture roofing shingles.

A belt sander is an example of a closed-loop web machine. A belt sander moves a web in the form of an abrasive belt over rollers in a closed-loop. Belt sanders enable workpieces to be sanded by the moving belt. A treadmill exercise device is another example of a closed-loop web machine.

Guiding the web moved by the web machine is necessary. Guiding the web maintains the web moving in a desired path and/or adjusts the desired path of the web. The web deviating from a desired path can cause the web machine to malfunction, can increase wear on the web, and/or can reduce the accuracy or effectiveness of how the web is processed. For example, printing may be misaligned if paper is not maintained in a desired path in a printing press.

Known web guides, such as sheet weave guides, lateral roller motion guides, or offset pivot roller guides, are not entirely satisfactory for the range of applications in which they are employed. For example, conventional web guides do not provide adequate means to dynamically change the effective diameter of a web guide roller. The inability to dynamically change the effective diameter of a roller limits the ability of conventional web guides to quickly alter the tension in the web to dynamically guide the web. It would be beneficial to have a web guide that enabled dynamically changing the effective diameter of a roller to enable swiftly counteracting changes in how a web is tracking within a web machine.

Further, existing web guides are undesirably complex, insufficiently reliable, and/or expensive. It would be desirable to have an improved and cost-effective web guide that effectively guided webs with a relatively simple, fast-responding mechanism.

The relatively large size of conventional web guides is less than ideal. Accommodating large web guides in web machines presents engineering challenges and can limit where conventional web guides or web machines with large conventional web guides installed may be used. It would be advantageous to have a relatively small and compact web guide that could be readily used in web machines without size-related constraints and engineering challenges.

Beyond web guides, vehicle propulsion and steering are functions that would benefit from innovation. It would be desirable to have a novel mechanism for propelling and steering vehicles. A mechanical arrangement for vehicle propulsion and steering that utilized roller assemblies would enable new and unique performance, reliability, and cost benefits.

Thus, there exists a need for roller assemblies that improve upon and advance the design of known roller assemblies. Examples of new and useful web guides relevant to the needs existing in the field are discussed below.

Examples of references relevant to web guides include US6546867B1, US6110093A, US5522785A, US20130108334A1, US20120066986A1, US5846177A, US5599015A, US5035037A, US2814484A, US2120735A, and US3760855A. The complete disclosures of the above patents and patent applications are herein incorporated by reference for all purposes.

### SUMMARY

The present disclosure is directed to roller assemblies configured to mount to a drive shaft and to engage a target surface. The roller assemblies include a tube wall, a control surface assembly, and a fin actuator.

The tube wall has a cylindrical shape and defines an interior space, an exterior surface, and slots. The interior space is radially surrounded by the tube wall. The exterior surface is configured to contact a target surface and defines an exterior surface diameter perpendicular to an axis of the tube wall. The slots pass through the tube wall from the interior space to the exterior surface.

The control surface assembly is disposed within the interior space. The control surface assembly includes fins aligned with the slots. The fins are adapted to selectively move between a retracted position contained within the tube wall and an extended position protruding beyond the exterior surface of the tube wall.

The fin actuator is configured to selectively move the fins between the retracted position and the extended position.

The fins include a control surface configured to contact a target surface when the fins are selectively moved to protrude beyond the exterior surface of the roller. The control surfaces of the fins collectively define a circumferential control surface extending around the tube wall and adapted to contact a target surface from a plurality of radial positions around the tube wall in place of a portion of the exterior surface of the tube wall. The circumferential control surface defines a control surface diameter perpendicular to the axis of the tube wall. The control surface diameter exceeds the exterior surface diameter by a variable amount based on how far the fins protrude beyond the exterior surface of the tube wall.

### BRIEF DESCRIPTION OF THE DRAWINGS

FIG. 1 is a perspective view of a first example of two web guides assembled together as a part of a web guide system.

FIG. 2 is an exploded view of one of the web guides shown in FIG. 1 depicting a roller, a control surface assembly, and a fin actuator spaced apart from each other.

FIG. 3 is a perspective view of the web guide shown in FIG. 2 with the fin actuator retracted relative to the control surface assembly sufficient for fins of the control surface assembly to be contained within the roller below the surface of the roller.

FIG. 4 is a perspective view of the web guide shown in FIG. 2 with the fin actuator extended toward the control surface assembly sufficient for fins of the control surface assembly to protrude beyond the surface of the roller.

FIG. 5 is a perspective view of the control surface assembly of the web guide shown in FIG. 2 with a fin pivoted up relative to a base member.

FIG. 6 is a front elevation view of the fin actuator of the web guide shown in FIG. 2.

FIG. 7 is a side elevation, cross section view of the control surface assembly and the fin actuator of the web guide shown in FIG. 2 depicting lobes of fins resting on inclined guide surfaces of the fin actuator.

FIG. 8 is a perspective view of a second example of a web guide, which includes pivoting links to raise and lower fins.

FIG. 9 is a side elevation view of the web guide shown in FIG. 8 with a link lowering a fin and other links and fins removed for clarity.

FIG. 10 is a side elevation view of the web guide shown in FIG. 8 with a link raising the fin and other links and fins removed for clarity.

FIG. 11 is a perspective view of a first example of a roller assembly.

FIG. 12 is an exploded view of the roller assembly shown in FIG. 11 depicting a tube wall, a control surface assembly at the center of the tube wall, and two fin actuators that move towards and away from the control surface assembly.

FIG. 13 is a perspective view of the control surface assembly of the roller assembly shown in FIG. 11.

FIG. 14 is a perspective view of the control surface assembly shown in FIG. 13 with two sets of fins removed to more clearly depict a base member on which the two sets of fins are pivotally mounted.

FIG. 15 is a perspective view of the roller assembly shown in FIG. 11 drivingly coupled to an axle of a vehicle to serve as a means of propelling and steering the vehicle.

### DETAILED DESCRIPTION

The disclosed web guides will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various web guides are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

### Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components.

“Communicatively coupled” means that an electronic device exchanges information with another electronic device, either wirelessly or with a wire-based connector, whether directly or indirectly through a communication network.

“Controllably coupled” means that an electronic device controls operation of another electronic device.

### Contextual Details

Ancillary features relevant to the web guides described herein will first be described to provide context and to aid discussing the web guides.

### Web and Web Machines

The web guides discussed in this document function to guide webs in web machines. Webs may be described as media, material, or substrates. The web guided by the web guides described below may be any currently known or later developed type of web, such as belts or rolls of paper or other substrates, such as tape, film, foil, and the like. The web guides may be used to guide webs in any currently known or later developed type of web machine, such as printing presses, battery separator film processing machines, or PET film machines, machines to produce roofing shingles, belt sanders, and treadmills.

Webs typically move through a web machine in a continuous or substantially continuous manner. For example, a web may be an abrasive belt that forms a continuous, closed loop within a belt sander web machine. Examples of substantially continuous webs are rolls of paper that pass through a printing press or rolls of film that pass through film processing machines.

The web guides described herein may also be used in web or belt conveyance systems. Suitable web conveyance system applications for the presently described web guides include conveyor belts used in warehouses, factories, farms, job sites, airports, and shipping facilities.

### Web Guides with Selectively Protruding Fins

With reference to the figures, web guides with selectively protruding fins will now be described. The web guides discussed herein function to guide webs passing through web machines.

The reader will appreciate that the devices disclosed herein have applications beyond guiding webs in web guide machines. For example, the devices and mechanisms described in this document may be used for steering vehicles, such as slower moving vehicles typically used in warehouses. The presently disclosed devices may be used in any application where dynamically changing the effective diameter of a roller or cylinder would be useful.

The reader will appreciate from the figures and description below that the presently disclosed web guides address many of the shortcomings of conventional web guides. For example, the novel web guides discussed herein enable dynamically changing the effective diameter of a web guide roller. As a result, the novel web guides are capable of quickly altering the tension in the web to dynamically guide the web. Beneficially, the novel web guides enable swiftly counteracting changes in how a web is tracking within a web machine.

Further, the novel web guides avoid the complexity, reliability issues, and expense of conventional web guides. Desirably, the novel web guides are cost-effective and reliably guide webs with a relatively simple, fast-responding mechanism. Advantageously, the novel web guides discussed below have a relatively small and compact footprint, which makes them suitable for ready use in web machines without size-related constraints or engineering challenges often present with large web guides.

### Web Guide Embodiment One

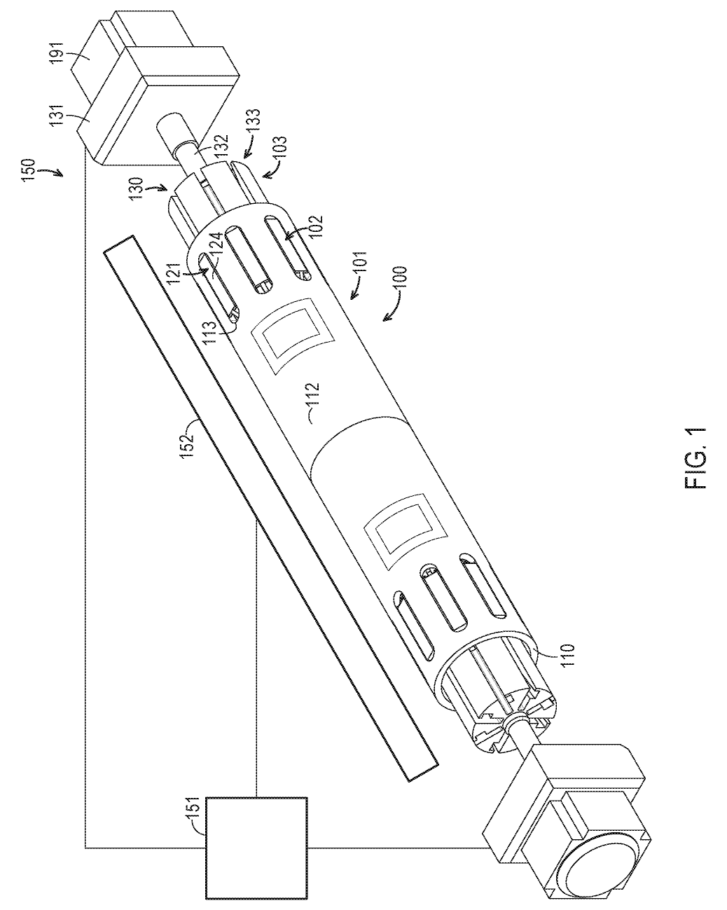

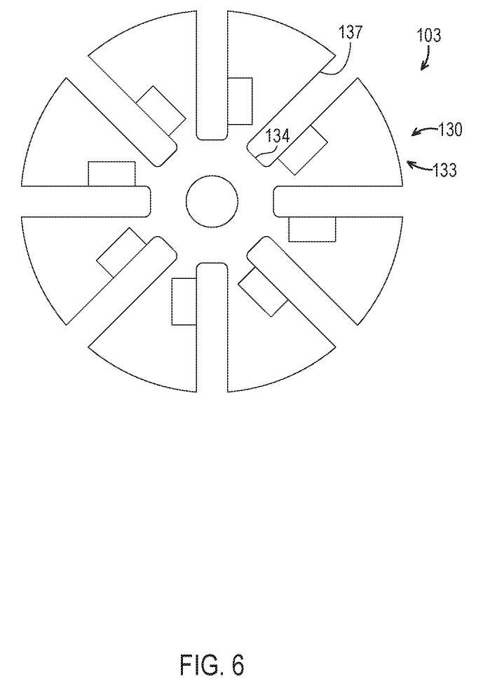

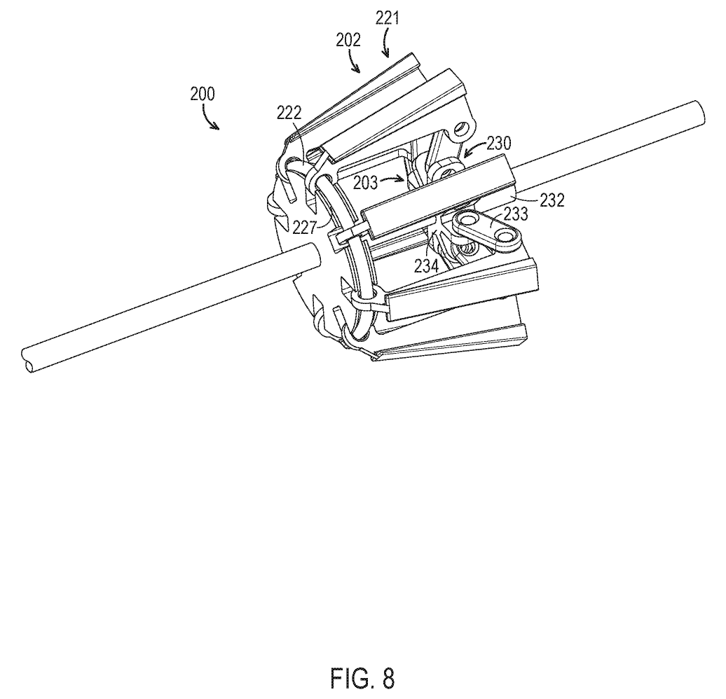

With reference to FIGS. 1-7, a first example of a web guide, web guide 100, will now be described. A second example of a web guide, web guide 200, is shown in FIGS. 8-10 and discussed in the Embodiment Two section below. Web guides 100 and 200 both function to guide a web within a web machine by dynamically changing the effective diameter of a control surface in contact with the web.

Web guide 100 includes a roller 101, a control surface assembly 102, and a fin actuator 103. In some examples, the web guide does not include one or more features included in web guide 100. In other examples, the web guide includes additional or alternative features. The components of web guide 100 are discussed in the sections below.

As shown in FIG. 1, web guide 100 may be part of a web guide system 150. Web guide system 150 includes web guide 100, a control unit 151, and a web sensor 152. Web guide systems utilizing web guides according to the present disclosure may include fewer, additional, or alternative components than control unit 151 and web sensor 152 depicted in FIG. 1.

The size and shape of the web guide may differ than the example shown in FIGS. 1-7. The reader should understand that different webs and web machines may indicate that a different size or shape web guide with the features and capabilities discussed herein should be used.

The number of web guides employed will vary in different applications. In some instances, a single web guide is effective to guide a web. As shown in FIG. 1, two axially aligned web guides 100 may be used to guide a web from opposite lateral sides of the web. In some applications, three or more web guides cooperate to guide a web.

In the example depicted in FIG. 1, each web guide 100 is configured the same. In other examples, the web guides may be configured differently. The discussion below will discuss one of the web guides 100 depicted in FIG. 1, and the reader should understand that the discussion pertains to the other web guide 100 depicted in FIG. 1 as well.

### Roller

Roller 101 functions to support a web and drive a web when rotated by a drive shaft. In some examples, the roller is not driven by a motor and instead passively rotates while supporting a web passing over it. Roller 101 also functions to house control surface assembly 102 and to isolate fin actuator 103 from a web passing over roller 101.

With reference to FIG. 1, the reader can see that roller 101 is configured to mount to a drive shaft. The drive shaft is rotated by a motor 191. Roller 101 rotates to drive a web forward in response to the drive shaft rotating roller 101. In other examples, the roller is not coupled to a drive shaft or motor and does not actively drive a web forward. In such examples, the roller passively rotates in response to the web it supports moving over it.

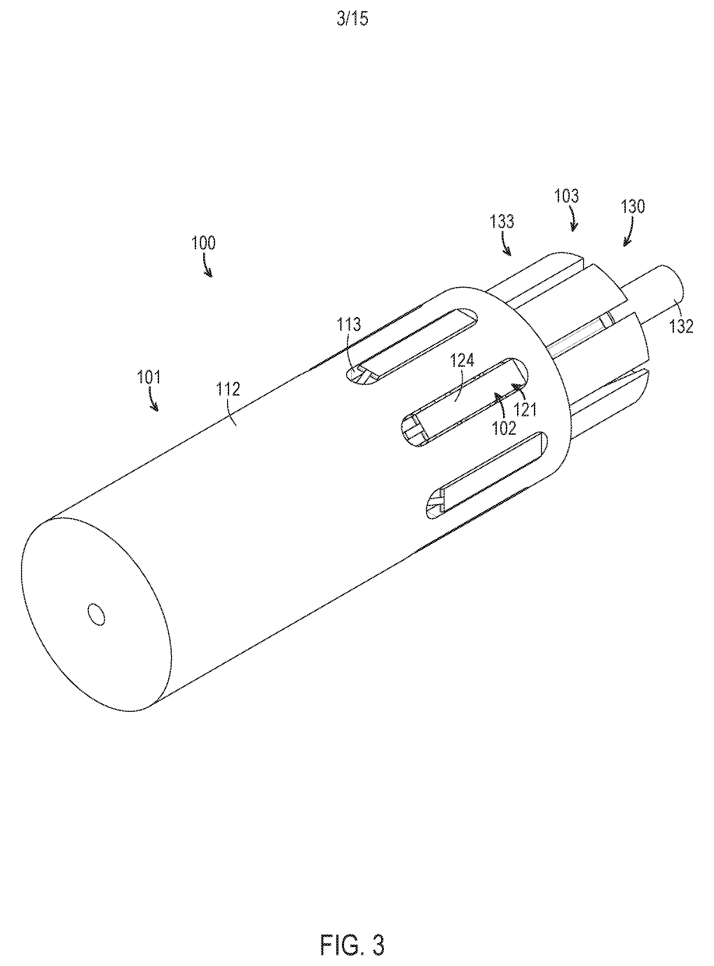

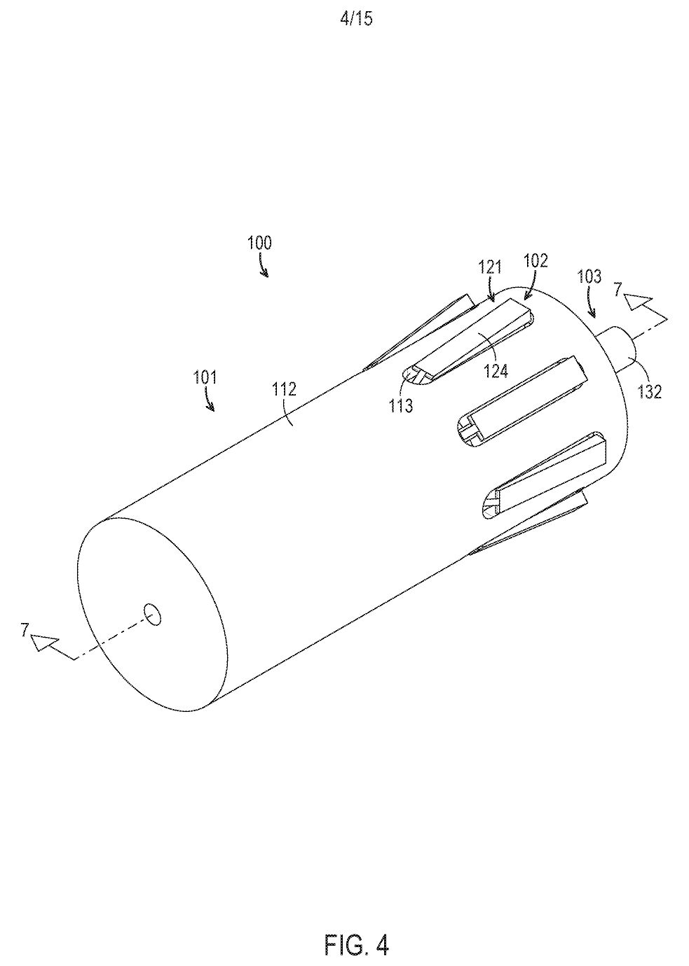

As demonstrated in FIGS. 1-4 and 7, roller 101, control surface assembly 102, and fin actuator 103 are coaxially arranged. Control surface assembly 102 is radially disposed between roller 101 and fin actuator 103. As shown in FIGS. 3 and 4, fin actuator 103 is configured to move within roller 101 to variable extents.

As shown in FIGS. 1-4 and 7, roller 101 includes a tube wall 110. Tube wall 110 defines an interior space 111, an exterior surface 112, and slots 113. Interior space 111 receives control surface assembly 102 and a portion of fin assembly 103. The drive shaft also extends through interior space 111.

Exterior surface 112 adapted to be in contact with web moving through a web machine. Exterior surface 112 supports the web and drives the web forward when roller 101 rotates.

As apparent from FIGS. 1-4 and 7, slots 113 are circumferentially spaced around tube wall 110. Slots 113 pass through the tube wall 110 from interior space 111 to exterior surface 112.

FIGS. 3 and 4 demonstrate that slots 113 allow fins 121 of control surface assembly 102 to move between interior space 111 and an exterior space beyond exterior surface 112. Fins 121 selectively projecting above exterior surface 112 changes the effective diameter of web guide 100, which may be referred to as a variable effective diameter of roller 101. When fins 121 are contained within interior space 111, the effective diameter of web guide 100 is the exterior diameter of roller 101. When fins 121 project through slots 113 above exterior surface 112, the effective diameter of web guide 100 is the space between control surfaces 124 of fins 121 on opposite sides of roller 101.

### Control Surface Assembly

Control surface assembly 102 functions to dynamically change the effective diameter of web guide 100. By changing the effective diameter of web guide 100, control surface assembly 102 functions to guide the web passing over roller 101 by modifying the tension in the web.

As shown in FIGS. 1-4 and 7, control surface assembly 102, roller 101, and fin actuator 103 are coaxially arranged. In particular, control surface assembly 102 is radially disposed between roller 101 and fin actuator 103. As apparent from FIGS. 1-4 and 7, control surface assembly 102 is disposed within interior space 111 of roller 101 underneath slots 113.

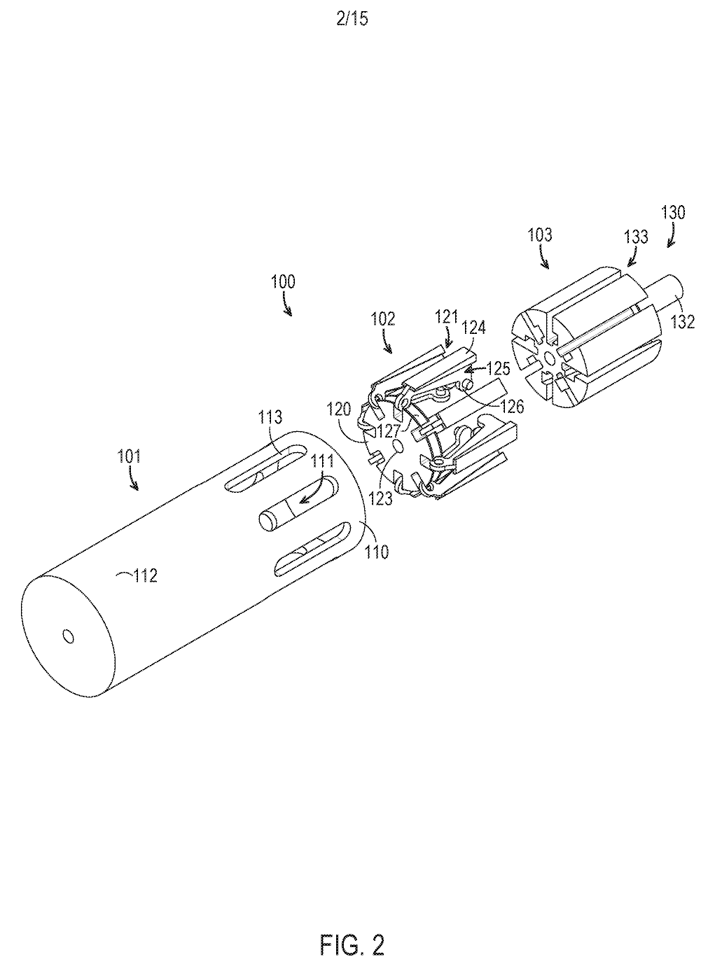

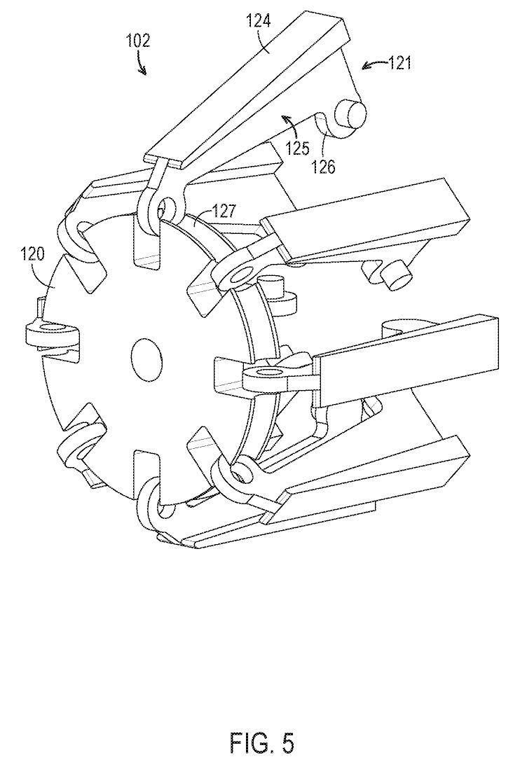

With reference to FIGS. 2 and 5, the reader can see that control surface assembly 102 includes a base member 120 and fins 121. The components of control surface assembly 102 are described in the sections below.

### Base Member

Base member 120 supports fins 121 and axially mounts control surface assembly 102 within roller 101. Base member 120 is disposed within interior space 111 closer to a longitudinal center of roller 101 than fins 121.

As shown in FIGS. 2 and 5, base member 120 is circular and oriented perpendicular to the longitudinal axis of roller 101. With continued reference to FIGS. 2 and 5, base member 120 defines a centerbore 123 adapted to receive and rest on an axial shaft. Base member 120 pivotally supports fins 121 around a circumference of base member 120.

As shown in FIGS. 2, 5, and 7, base member 120 defines a circumferential recess 127. Circumferential recess 127 receives a ring (not pictured, but similar to ring 222 depicted in FIGS. 8-10). Circumferential recess 127 defines a pivot position of control surface assembly 102.

Fins 121 are pivotally mounted to the ring disposed in circumferential recess 127. Fins 121 pivot around the ring between the retracted position and the extended position. The ring may be formed from wire or any suitable bearing member. In other examples, a hinge or other pivot-facilitating structure is used in place of or in addition to the ring.

### Fins

Fins 121 function to interface with a web passing over roller 101. Fins 121 dynamically change the effective diameter of web guide 100. By changing the effective diameter of web guide 100, fins 121 guide the web passing over roller 101 by modifying the tension in the web.

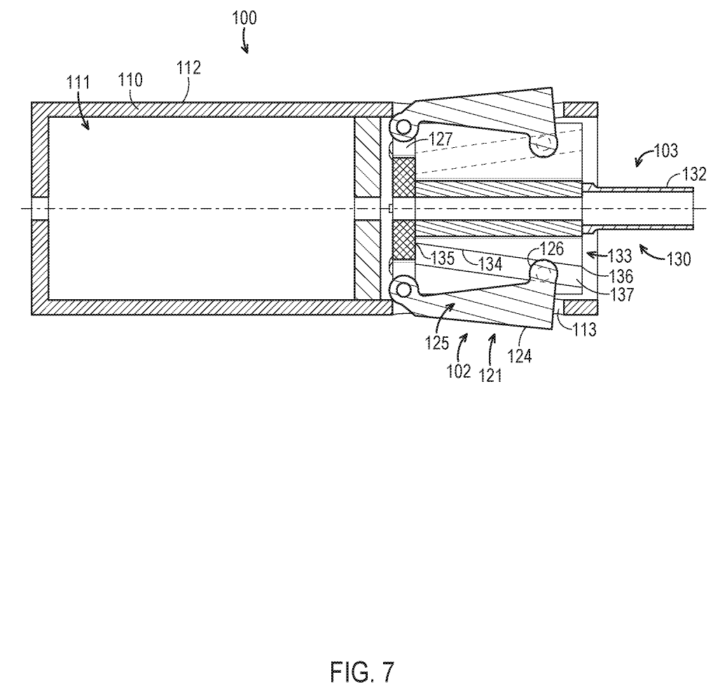

As apparent in FIGS. 1-4, fins 121 are aligned with slots 113. Fins 121 are adapted to selectively move between a retracted position shown in FIG. 3 and an extended position shown in FIGS. 4 and 7. In the retracted position, fins 121 are contained within roller 101. In the extended position, fins 121 protrude beyond exterior surface 112 of roller 101.

Fins 121 include a control surface 124 facing away from the longitudinal axis of web guide 100. Control surfaces 124 are configured to engage a web when fins 121 are selectively pivoted beyond exterior surface 112 of roller 101. The extent to which fins 121 are pivoted beyond exterior surface 112 guides the web to a proportionate degree.

Fins 121 selectively projecting control surfaces 124 above exterior surface 112 changes the effective diameter of web guide 100, which may be referred to as a variable effective diameter of roller 101. When control surfaces 124 are contained within interior space 111 below exterior surface 112, the effective diameter of web guide 100 is the exterior diameter of roller 101. When control surfaces 124 project through slots 113 above exterior surface 112, the effective diameter of web guide 100 is the space between control surfaces 124 of fins 121 on opposite sides of roller 101.

As shown in FIGS. 4 and 7, control surfaces 124 are oriented transverse to exterior surface 112 at a control surface angle when fins 121are selectively pivoted beyond exterior surface 112. Pivoting fins 121 beyond exterior surface 112 towards the extended position defines a range of control surface angles between control surface 124 and exterior surface 112. Greater control surface angles increase the tension on the web and cause web guide 100 to guide the web to a greater extent.

As demonstrated in FIGS. 5 and 7, fins 121 define a fin profile 125. Fin profile 125 is adapted to interface with a guide surface 134 of fin actuator 103. In particular, fin profile 125 includes a lobe 126 adapted to travel along guide surface 134 as fin actuator 103 translates a cam 130 axially relative to fins 121. Lobe 126 traveling along guide surface 134 selectively pivots fins 121 between the retracted position and the extended position.

In the example shown in FIGS. 2 and 5, control surface assembly 102 includes eight fins 121. Correspondingly, roller 101 defines eight slots 113 through which the eight fins 121 may extend. However, the web guides may include fewer or additional fins and slots, such as a single fin and slot, between two and seven fin and slot pairs, or more than eight fin and slot pairs.

The size and shape of the fins may vary in different examples. For example, the fins may be larger or smaller than the other web guide components than depicted in FIGS. 1-7. In the present example, control surfaces 124 are flat. However, the control surfaces could be curved, ridged, or discontinuous in other examples.

### Fin Actuator

Fin actuator 103 is configured to selectively move fins 121 between the retracted position and the extended position. In particular, fin actuator 103 is configured to selectively pivot fins 121 between the retracted position and the extended position by engaging lobes 126 when fin actuator 103 moves axially relative to fins 121.

The reader can see in FIGS. 1-4 and 7 that fin actuator 103 is coaxially arranged with roller 101 and control surface assembly 102. Fin actuator 103 is selectively disposed within control surface assembly 102 by axially translating relative to control surface assembly 102. When fin actuator 103 is disposed within control surface assembly 102, fin actuator 103 is also disposed inside roller 101.

As shown in FIGS. 1-3, 6, and 7,fin actuator 103 includes a cam 130 and a linear actuator 131. The components of fin actuator 130 are described in the sections below.

Other mechanisms for selectively moving the fins between the retracted position and the extended positions are contemplated. For example, the fins may be selectively raised and lowered via a mechanism including a pneumatic reservoir and pump assembly. Additionally or alternatively, individual motorized actuators could control fin motion.

### Cam

Cam 130 functions to selectively pivot fins 121 between the retracted position and the extended position. Cam 130 selectively pivots fins 121 between the retracted position and the extended position by engaging lobes 126 when linear actuator 131 moves cam 130 axially relative to fins 121.

As shown in FIG. 1, cam 130 is mounted to linear actuator 131 and is selectively translated axially by linear actuator 131. Cam 130 includes a cam shaft 132 mounted to linear actuator 131. Cam 130 further includes a guide member 133 mounted to cam shaft 132.

As shown in FIGS. 1-3 and 6, guide member 133 defines guide slots 137. Guide slots 137 are complementarily configured with fins 121 and aligned with fins 121. Accordingly, fins 121 can pass through slots 137 as cam 130 axially translates relative to fins 121.

As shown in FIGS. 1-3, 6, and 7,guide slots 137 define guide surfaces 134. Guide surfaces 134 are configured to pivot fins 121 between the retracted position and the extended position. Guide surfaces 134 pivot fins 121 by engaging lobes 126 as guide member 133 moves axially relative to lobes 126 in response to liner actuator 131 axially translating cam 130.

As can be seen in FIG. 7, guide surfaces 134 are tapered. Guide surfaces include a leading end 135 and a trailing end 136. Leading end 135 is proximate base member 120 and trailing end 136 is disposed opposite leading end 135 and distal base member 120. FIG. 7 demonstrates that the height of leading end 135 is less than the height of trailing end 136.

### Linear Actuator

Linear actuator 131 is configured to translate cam 130 relative to control surface assembly 102. Linear actuator 131 translating cam 130 towards base member 120 pivots fins 121 between the retracted position and the extended position. As shown in FIG. 1, linear actuator 131 supports cam 130 by cam shaft 132.

As further shown in FIG. 1, linear actuator 131 is controllably coupled to control unit 151. Control unit 151 dynamically directs linear actuator 131 to axially translate cam 130 towards base member 120 and away from base member 120 in response to sensor inputs received from web sensor 152. For example, control unit 151 may direct linear actuator 131 to move cam 130 towards base member 120 to raise fins 121 when inputs from web sensor 152 indicate that the web is tracking away from the longitudinal center of roller 101 instead of along a desired tracking path centered on roller 101.

The linear actuator may be any currently known or later developed type of linear actuator. In some examples, the linear actuator pneumatically, electrically, or magnetically translates the cam. Any suitable means for translating the cam may be utilized by the linear actuator. The size and shape of the linear actuator may be different than depicted in FIG. 1.

### Web Guide System

Web guide system 150 functions to dynamically guide a web with web guide 100 based on detected tracking behavior of the web over roller 101. The detected position of the web relative to roller 101 at a given time is used by control unit 151 to dynamically instruct linear actuator 131 to translate cam 130 to modify the effective diameter of web guide 100 as necessary to guide the web along a desired path. As shown in FIG. 1, web guide system 150 includes web guide 100, a control unit 151, and a web sensor 152.

Web sensor 152 detects the tracking behavior of the web dynamically. Web sensor 152 supplies control unit 151 with sensor inputs, which correspond to the tracking behavior of the web as dynamically detected by web sensor 152. Web sensor 152 is in wireless data communication with control unit 151, but may be in wired data communication in other examples.

The web sensor may be any currently known or later developed type of sensor adapted to detect the position or tracking behavior of a web in a web machine. Suitable web sensors include infrared edge sensors, ultrasonic edge sensors, capacitive sensors, and optical sensors.

Control unit 151 dynamically instructs linear actuator 131 to translate cam 130 to modify the effective diameter of web guide 100 as necessary to guide the web along a desired path. Control unit 151 utilizes sensor inputs from web sensor 152 to dynamically determine instructions for linear actuator 131. The control unit may be any currently known or later developed type of controller suitable for translating cams.

### Second Embodiment

Turning attention to FIGS. 8-10, a second example of a web guide, web guide 200, will now be described. Web guide 200 includes many similar or identical features to web guide 100. Thus, for the sake of brevity, each feature of web guide 200 is not redundantly explained. Rather, key distinctions between web guide 200 and web guide 100 are highlighted, and the reader should reference the discussion above for features substantially similar between the different web guide examples.

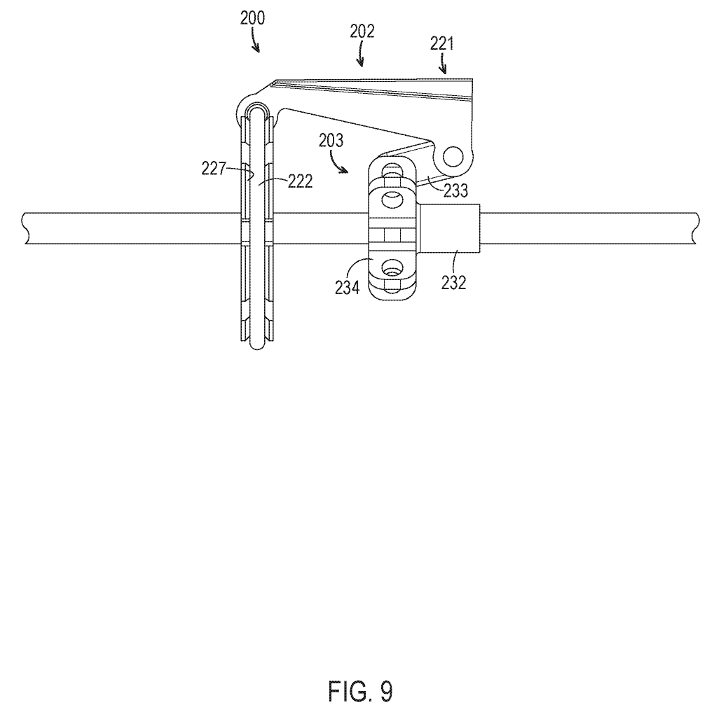

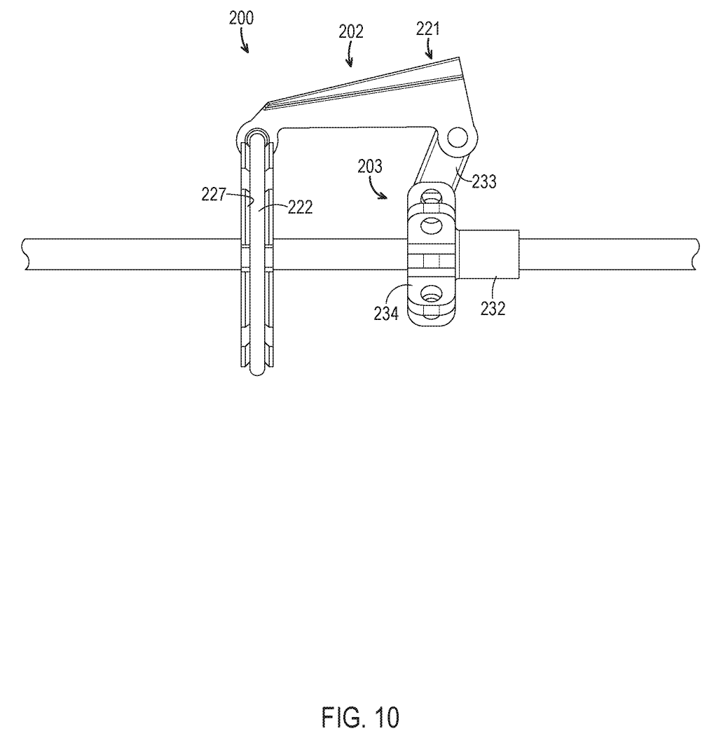

With reference to FIGS. 8-10, web guide 200 includes a roller (not pictured), a control surface assembly 202, and a fin actuator 203. Like web guide 100, web guide 200 functions to guide a web moving over the roller by changing the effective diameter of the roller. Fins 221 of control surface assembly 202 changes the effective diameter of the roller when fins 221 are moved by fin actuator 203. Fin actuator 203 moves fins 221 between a retracted position shown in FIG. 9 and an extended position shown in FIG. 10.

With reference to FIGS. 8-10, the reader can see that base member 220 defines a circumferential recess 227. Circumferential recess 227 receives a ring 222. Circumferential recess 227 defines a pivot position of control surface assembly 202.

As shown in FIGS. 8-10, fins 221 are pivotally mounted to ring 222 disposed in circumferential recess 227. Fins 221 pivot around ring 222 between the retracted position and the extended position. In the present example, ring 222 is formed from wire, but may be any suitable bearing member. In other examples, a hinge or other pivot-facilitating structure is used in place of or in addition to the ring.

Fin actuator 203 is configured differently than fin actuator 103. Whereas fin actuator 103 pivoted fins 121 with cam 130 and linear actuator 131, fin actuator 203 pivots fins 221 with a linkage 230 and a linear actuator (not pictured). Linkage 230 is pivotally coupled to fins 221 and extends and retracts fins 221 in response to being translated axially by the linear actuator.

As shown in FIGS. 8-10, linkage 230 includes a shaft 232, a hub 234, and pivot links 233. Shaft 232 is translated axially by the linear actuator. Hub 234 is mounted on shaft 232 and translates axially when shaft 232 is translated axially by the linear actuator.

Pivot links 233 are pivotally coupled to hub 234 around a radial periphery of hub 234. Pivot links 233 further pivotally couple to fins 221. When the linear actuator axially translates hub 234 away from the pivotal connection point between pivot links 233 and fins 221, fins 221 are pulled by pivot links 233 toward the retracted position shown in FIG. 9. When the linear actuator axially translates hub 234 towards the pivotal connection point between pivot links 233 and fins 221, fins 221 are pushed by pivot links 233 towards the extended position shown in FIG. 10.

The length of the pivot links may be different than shown in FIGS. 8-10 in other examples. Longer pivot links may be selected to increase the range of motion of the fins and to thereby increase the effective diameter range of the web guide. Shorter pivot links may be selected to decrease the range of motion of the fins and to thereby decrease the effective diameter range of the web guide.

### Third Embodiment

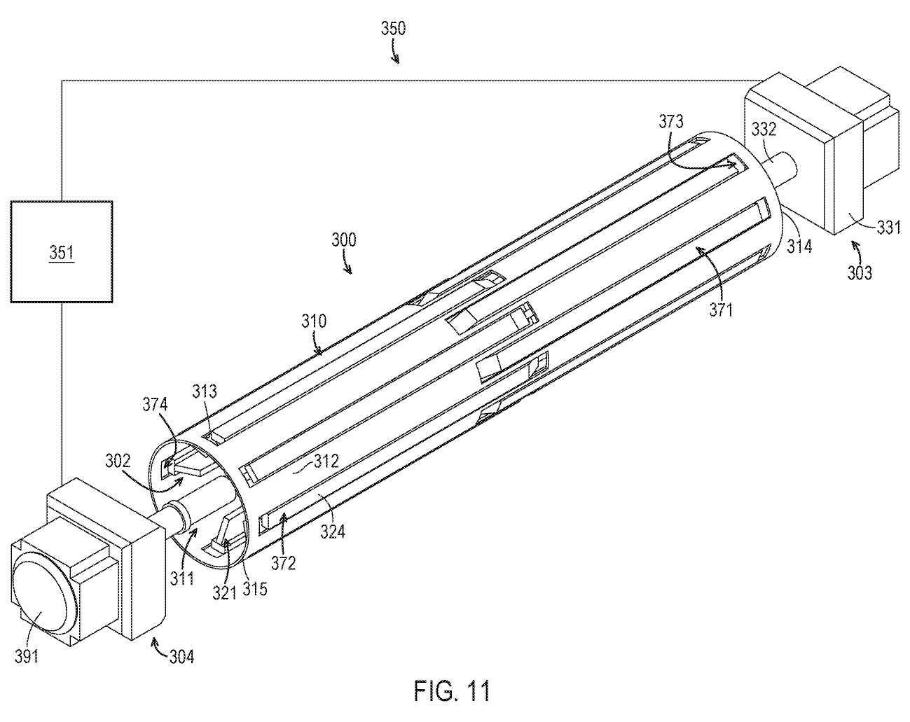

With reference to FIGS. 11-15, a roller assembly 300 will now be described. Roller assembly 300 includes many similar or identical features to web guides 100 and 200. Thus, for the sake of brevity, each feature of roller assembly 300 is not redundantly explained. Rather, key distinctions between roller assembly 300 and web guides 100 and 200 are highlighted, and the reader should reference the discussion above for features substantially similar between the different examples.

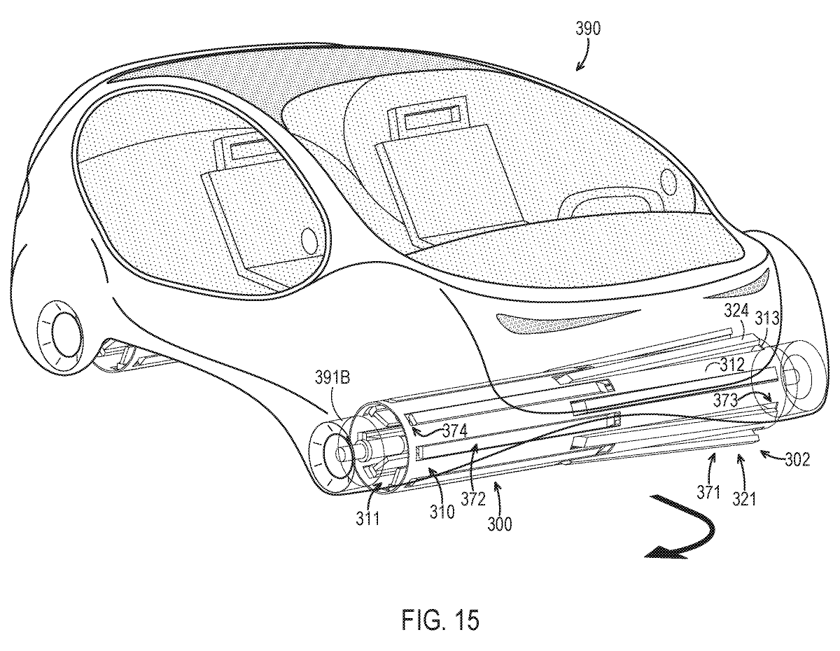

FIG. 15 highlights one application of roller assembly 300; namely, propelling and steering a vehicle 390. As depicted by the curved arrow in FIG. 15, roller assemblies 300 operate to propel vehicle 390 forward while steering it to the right. Vehicle propulsion and steering are not the only applications contemplated for roller assemblies designed similarly to roller assembly 300. Roller assemblies consistent with roller assembly 300 may be used to guide webs or brush surfaces. The roller assemblies may be used for any currently known or later developed roller applications.

The roller assemblies described herein may be used with a wide variety of vehicle types, including passenger vehicles, all-terrain vehicles, golf carts, forklifts, and others. The roller assemblies may mechanically integrate into vehicles by any suitable means, such as by coupling to a drive shaft of a vehicle. Any currently known or later developed type of vehicle and mechanical coupling means may be used to utilize the roller assemblies described herein for vehicle propulsion and steering.

As shown in FIG. 11, roller assembly 300 is configured to mount to and be driven by a drive shaft. The drive shaft is rotated by motors 391 shown in FIG. 11 or by motors 391B of vehicle 390 depicted in FIG. 15. Motors 391B depicted in FIG. 15 are configured differently than motors 391 depicted in FIG. 11, but perform the same function. Roller assembly 300 rotates when driven by the drive shaft.

Roller assembly 300 is configured to engage a target surface. In the example shown in FIG. 15, the target surface is the ground or road on which vehicle 390 travels. In other examples, the target surface is a web that the roller assembly guides. Roller assembly 300 exerts force on the target surface, which functions to propel and steer vehicle 390 via reaction forces exerted on roller assembly 300 and vehicle 390 to which roller assembly 300 is mechanically coupled.

As shown in FIGS. 11-15, roller assembly includes a tube wall 310, a control surface assembly 302, and fin actuators 303. In some examples, the roller assembly does not include one or more features included in roller assembly 300. In other examples, the roller assemblies include additional or alternative features. The components of roller assembly 300 are discussed in the sections below.

As shown in FIG. 11, roller assembly 300 may be part of a roller system 350. Roller system 350 includes roller assembly 300, a control unit 351, motors 391, and drive shafts. Roller systems utilizing roller assemblies according to the present disclosure may include fewer, additional, or alternative components than control unit 351, motors 391, and the drive shafts depicted in FIG. 11.

The size and shape of the roller assembly may differ than the example shown in FIGS. 11-15. The reader should understand that different applications will dictate that different sizes or shapes for the roller assemblies should be used. For example, roller assembly 300 used to propel and steer vehicle 390 may be significantly larger than a similarly configured roller assembly used to guide webs.

The number of roller assemblies employed will vary in different applications. In some instances, like shown in FIG. 15, two roller assemblies 300 are used to propel and steer vehicle 390. However, in some examples a single roller assembly is effective to propel and steer a vehicle. In other examples, three or four roller assemblies are used in vehicle applications.

When multiple roller assemblies are used in combination, each roller assembly may be configured the same or may be configured differently.

### Tube Wall

As shown in FIGS. 11-15, tube wall 310 has a cylindrical shape and defines an interior space 311, an exterior surface 312, and slots 313. Tube wall 310 includes a first axial end 314 and a second axial end 315 opposite first axial end 314.

Interior space 311 is radially surrounded by tube wall 310 and receives control surface assembly 302 and a portion of fin actuators 303. In some examples, depending on the geometry of the fin actuators, the fin actuators may reside entirely within the interior space. The drive shafts also extend through interior space 311.

As shown in FIG. 15, exterior surface 312 is configured to contact a target surface, which is a road on which vehicle 390 travels. Exterior surface 312 engaging the target surface when tube wall 310 is driven by motors 391B exerts force on the target surface, which functions to propel and steer vehicle 390. Exterior surface 312 defines an exterior surface diameter perpendicular to an axis of tube wall 310.

FIGS. 11, 12, and 15 demonstrate that slots 313 pass through tube wall 310 from interior space 311 to exterior surface 312. Slots 313 are longer than slots 113 discussed above to accommodate longer fins 321.

As shown in FIGS. 11, 12, and 15, tube wall 310 defines two sets of slots 373 and 374. First set of slots 373 is circumferentially spaced around tube wall 310 at a first axial position along tube wall 310. Second set of slots 374 is circumferentially spaced around tube wall 310 at a second axial position along tube wall 310.

The second axial position is axially offset from the first axial position. Further, the second axial position is proximal to second axial end 315 of tube wall 310 while the first axial position is proximal to first axial end 314 of tube wall 310. First set of slots 373 is defined between the axial center of tube wall 310 and first axial end 314 of tube wall 310 while second set of slots 374 is defined between the axial center of tube wall 310 and second axial end 315 of tube wall 310.

Slots 313 allow fins 321 to move between interior space 311 and an exterior space beyond exterior surface 312. Fins 321 selectively projecting above exterior surface 312 changes the effective diameter of roller assembly 300, which may be referred to as a variable effective diameter of tube wall 310. When fins 321 are contained within interior space 311, the effective diameter of roller assembly 300 is the exterior diameter of tube wall 310. When fins 321 project through slots 313 above exterior surface 312, the effective diameter of roller assembly 300 is the space between control surfaces 324 of fins 321 on opposite sides of tube wall 301.

### Control Surface Assembly

As shown in FIGS. 11, 12, and 15, control surface assembly 302, tube wall 310, and fin actuators 303 are coaxially arranged. In particular, control surface assembly 302 is radially disposed between tube wall 310 and fin actuator 303. As apparent from FIGS. 11 and 15, control surface assembly 302 is at least partially disposed within interior space 311 underneath slots 313, and fins 321 of control surface assembly 302 may selectively extend out of interior space 311 through slots 313.

With reference to FIGS. 11-15, the reader can see that control surface assembly 302 includes a base member 320 and two sets of fins 371 and 372. The components of control surface assembly 302 are described in the sections below.

### Base Member

Base member 320 supports fins 321 and axially mounts control surface assembly 302 within tube wall 310. Base member 320 is disposed within interior space 311 and is centered on a longitudinal center of tube wall 310.

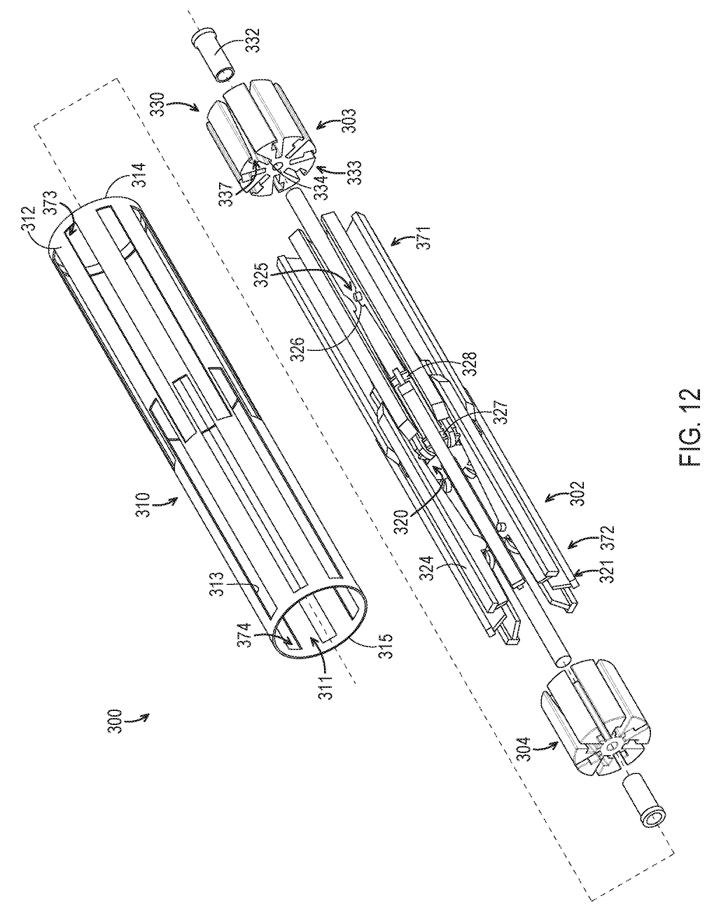

As shown in FIGS. 12-14, base member 320 is substantially cylindrical and axially aligned with the longitudinal axis of tube wall 310. With continued reference to FIGS. 12-14, base member 320 defines a centerbore 323 adapted to receive and rest on an axial shaft.

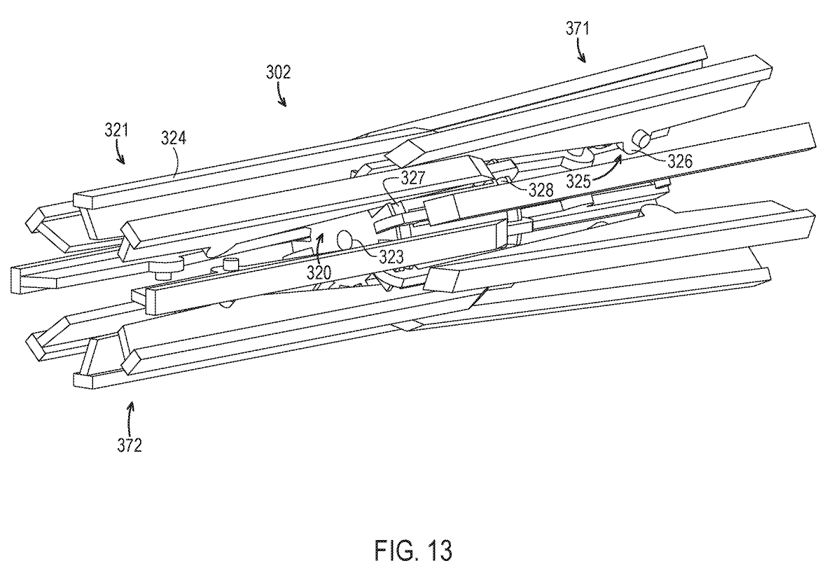

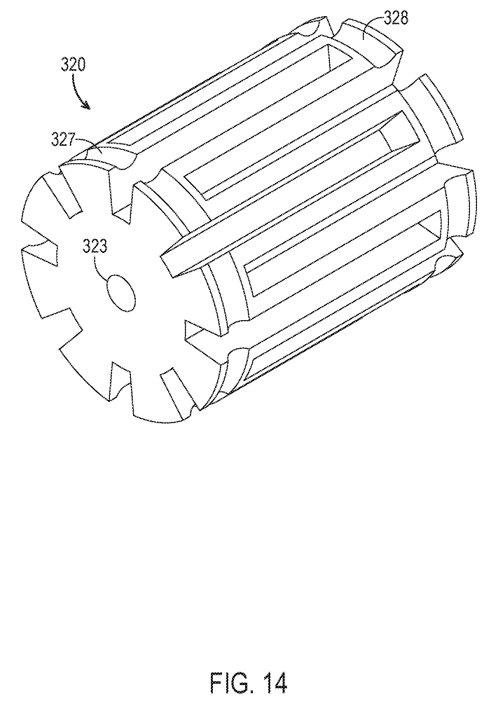

As depicted in FIGS. 13 and 14, base member 320 and rings (not pictured, but similar to ring 222) pivotally support fins 321 around a circumference of base member 320. In particular, base member 320 and a second ring support a first set of fins 371 extending from a second pivot position 327 towards a first axial end 314 of tube wall 310. Base member 320 and a first ring support supports a second set of fins 372 extending from a first pivot position 328 towards a second axial end 315 of tube wall 310.

First and second pivot positions 327 and 328 are circumferential recesses (similar to recesses 127 and 227) formed in based member 320 in which rings are disposed. The rings pivotally secure fins 121 at first and second pivot positions 327 and 328. In other examples, hinges or other pivot-facilitating structures are used in place of or in addition to the rings.

First set of fins 371 are aligned with first set of slots 373 and second set of fins 372 are aligned with second set of slots 374. The reader can see in FIGS. 12 and 13 that portions of first set of fins 371 and second set of fins 372 are axially aligned and circumferentially spaced proximal to the axial center of tube wall 310.

### Fins

Fins 321 function to interface with a target surface over which tube wall 310 is rotating. Fins 321 dynamically change the effective diameter of roller assembly 300. By changing the effective diameter of roller assembly 300, fins 321 steer vehicle 390, such as causing vehicle 390 to turn right like depicted in FIG. 15. In other applications, the fins changing the effective diameter of the roller assembly functions to guide a web passing over the tube wall by modifying the tension in the web.

As apparent in FIGS. 11, 12, and 15, fins 321 are aligned with slots 313. Fins 321 are adapted to selectively move between a retracted position and an extended position. The retracted position is shown in FIG. 11 and on the right side of vehicle 390 in FIG. 15. The extended position is shown on the left side of vehicle 390 in FIG. 15. In the retracted position, fins 321 are contained within interior space 311 of tube wall 310. In the extended position, fins 321 protrude beyond exterior surface 312 of tube wall 310.

Fins 321 include a control surface 324 facing away from the longitudinal axis of tube wall 310. Control surfaces 324 are configured to engage a target surface when fins 321 are selectively pivoted beyond exterior surface 312 of tube wall 310. The extent to which fins 321 are pivoted beyond exterior surface 312 steers vehicle 390 to a proportionate degree.

Fins 321 selectively projecting control surfaces 324 above exterior surface 312 changes the effective diameter of roller assembly 300, which may be referred to as a variable effective diameter of roller assembly 300. When control surfaces 324 are contained within interior space 311 below exterior surface 312, the effective diameter of roller assembly 300 is the exterior diameter of tube wall 310. When control surfaces 324 project through slots 313 above exterior surface 312, the effective diameter of roller assembly 300 is the space between control surfaces 324 of fins 321 on opposite sides of tube wall 310.

Expressed another way, control surfaces 324 of fins 321 collectively define a circumferential control surface. In more detail, first set of fins 371 define a first circumferential control surface while second set of fins 372 define a second circumferential control surface. As shown in FIG. 15, the circumferential control surfaces extend around tube wall 310 and are adapted to contact a target surface from a plurality of radial positions around tube wall 310. As demonstrated in FIG. 15, control surfaces 324 selectively contact the target surface in place of a portion of exterior surface 312 of tube wall 310.

The circumferential control surface of fins 321 defines a control surface diameter perpendicular to the axis of tube wall 310. The control surface diameter exceeds the exterior surface diameter of tube wall 310 by a variable amount based on how far fins 321 protrude beyond exterior surface 312 of tube wall 310.

As shown on the left side of vehicle 390 in FIG. 15, control surfaces 324 are oriented transverse to exterior surface 312 at a control surface angle when fins 321are selectively pivoted beyond exterior surface 312. Pivoting fins 321 beyond exterior surface 312 towards the extended position defines a range of control surface angles between control surface 324 and exterior surface 312. Greater control surface angles cause roller assembly 300 to steer vehicle 390 to a greater extent.

As demonstrated in FIGS. 12 and 13, fins 321 define a fin profile 325. Fin profile 325 is adapted to interface with guide surfaces 334 of fin actuators 303, which are shown in FIG. 12. In particular, fin profile 325 includes a lobe 326 adapted to travel along guide surfaces 334 as fin actuators 303 translate cams 330 axially relative to fins 321. Lobe 326 traveling along guide surface 334 selectively pivots fins 321 between the retracted position and the extended position.

In the example shown in FIGS. 11-13 and 15, control surface assembly 302 includes sixteen fins 321. Correspondingly, tube wall 310 defines sixteen slots 313 through which the sixteen fins 321 may extend. However, the roller assemblies may include fewer or additional fins and slots, such as a single fin and slot, between two and fifteen fin and slot pairs, or more than sixteen fin and slot pairs.

The size and shape of the fins may vary in different examples. For example, the fins may be larger or smaller than the other roller assembly components than depicted in FIGS. 11-15. In the present example, control surfaces 324 are flat. However, the control surfaces could be curved, ridged, or discontinuous in other examples.

### Fin Actuator

Fin actuators 303 and 304 are configured to selectively move fins 321 between the retracted position and the extended position. In particular, fin actuators 303 and 304 are configured to selectively and independently move first set of fins 371 and second set of fins 372 between the retracted position and the extended position. A first fin actuator 303 selectively moves first set of fins 371 while a second fin actuator 304 selectively moves second set of fins 372. Fin actuators 303 and 304 are configured to selectively pivot fins 321 between the retracted position and the extended position by engaging lobes 326 on fins 321 when fin actuators 303 and 304 move axially relative to fins 321.

The reader can see in FIGS. 12 that fin actuator 303 is coaxially arranged with tube wall 310 and control surface assembly 302. Fin actuators 303 are selectively disposed within control surface assembly 302 by axially translating relative to control surface assembly 302. When a fin actuator 303 is disposed within control surface assembly 302, it is also disposed inside tube wall 310.

As shown in FIG. 12, each of fin actuators 303 and 304 include a cam 330 and a linear actuator 331. The components of fin actuators 303 and 304 are described in the sections below. The components of a single fin actuator 303 are described below with the understanding that the discussion applies to both fin actuators 303 and 304 included in roller assembly 300.

Other mechanisms for selectively moving the fins between the retracted position and the extended positions are contemplated. For example, the fins may be selectively raised and lowered via a mechanism including a pneumatic reservoir and pump assembly. Additionally or alternatively, individual motorized actuators could control fin motion.

### Cam

Cam 330 functions to selectively pivot fins 321 between the retracted position and the extended position. Cam 330 selectively pivots fins 321 between the retracted position and the extended position by engaging lobes 326 when linear actuator 331 moves cam 330 axially relative to fins 321.

FIGS. 11 and 12 in combination depict how cams 330 are mounted to linear actuators 331 and are selectively translated axially by linear actuators 331. A first cam 330 is disposed between the axial center of tube wall 310 and first axial end 314 of tube wall 310 and is operable to selectively move between the axial center and first axial end 314 to selectively to selectively pivot first set of fins 371 through first set of slots 373 between the retracted position and the extended position. A second cam 330 is disposed between the axial center and second axial end 315 and is operable to selectively move between the axial center and second axial end 315 to selectively pivot second set of fins 372 through second set of slots 374 between the retracted position and the extended position.

Each cam 330 includes a cam shaft 332 mounted to one of linear actuators 331. Each cam 330 further includes a guide member 333 mounted to cam shaft 332.

As shown in FIG. 12, guide member 333 defines guide slots 337. Guide slots 337 are complementarily configured with fins 321 and aligned with fins 321. Accordingly, fins 321 can pass through slots 337 as cam 330 axially translates relative to fins 321.

As depicted in FIG. 12, guide slots 337 define guide surfaces 334. Guide surfaces 334 are configured to pivot fins 321 between the retracted position and the extended position. Guide surfaces 334 pivot fins 321 by engaging lobes 326 as guide member 333 moves axially relative to lobes 326 in response to liner actuator 331 axially translating cam 330.

### Linear Actuators

Linear actuators 331 are configured to translate cams 330 relative to control surface assembly 302. Linear actuators 331 translating cams 330 towards base member 320 pivots the first and second sets of fins 371 and 372 between the retracted position and the extended position.

As shown in FIG. 11, linear actuators 331 are controllably coupled to control unit 351. Control unit 351 dynamically directs linear actuators 331 to axially translate cams 330 towards base member 320 and away from base member 320 in response to sensor or control inputs received. For example, control unit 351 may direct linear actuator 331 proximal to first axial end 314 to move cam 330 proximal to first axial end 314 towards base member 320 to raise first set of fins 371 when a user turns a steering wheel to the right. The user turning the steering wheel to right indicates a desire to turn vehicle 390 to the right, and linear actuator 331 causing first set of fins 371 to extend through first set of slots 373 beyond exterior surface 312 effectuates steering vehicle 390 to the right like depicted in FIG. 15.

The linear actuator may be any currently known or later developed type of linear actuator. In some examples, the linear actuator pneumatically, electrically, or magnetically translates the cam. Any suitable means for translating the cam may be utilized by the linear actuator. The size and shape of the linear actuator may be different than depicted in FIG. 11.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A roller assembly configured to mount to a drive shaft and to engage a target surface, the roller assembly comprising:
a tube wall having a cylindrical shape and defining:
an interior space radially surrounded by the tube wall;
an exterior surface configured to contact a target surface and that defines an exterior surface diameter perpendicular to an axis of the tube wall; and
slots passing through the tube wall from the interior space to the exterior surface; and
a control surface assembly disposed within the interior space, the control surface assembly including fins aligned with the slots and adapted to selectively move between a retracted position contained within the tube wall and an extended position protruding beyond the exterior surface of the tube wall; and
a fin actuator configured to selectively move the fins between the retracted position and the extended position;
wherein:
each fin includes a control surface configured to contact a target surface when the fins are selectively moved to protrude beyond the exterior surface of the tube wall;
the control surfaces of the fins collectively define a circumferential control surface extending around the tube wall and adapted to contact a target surface from a plurality of radial positions around the tube wall in place of a portion of the exterior surface of the tube wall;
the circumferential control surface defines a control surface diameter perpendicular to the axis of the tube wall; and
the control surface diameter exceeds the exterior surface diameter by a variable amount based on how far the fins protrude beyond the exterior surface of the tube wall.

2. The roller assembly of claim 1, wherein the slots include:
a first set of slots circumferentially spaced around the tube wall at a first axial position along the tube wall; and
a second set of slots circumferentially spaced around the tube wall at a second axial position along the tube wall, the second axial position being axially offset from the first axial position.

3. The roller assembly of claim 2, wherein the fins include:
a first set of fins aligned with the first set of slots; and
a second set of fins aligned with the second set of slots.

4. The roller assembly of claim 3, wherein the fin actuator is configured to selectively and independently move the first set of fins and the second set of fins between the retracted position and the extended position.

5. The roller assembly of claim 4, wherein:
each fin in the first set of fins and in the second set of fins includes a control surface configured to contact a target surface when the fins are selectively moved to protrude beyond the exterior surface of the roller;
the control surfaces of the first set of fins collectively define a first circumferential control surface extending around the tube wall and adapted to contact a target surface in place of a portion of the exterior surface from a plurality of radial positions around the tube wall;
the control surfaces of the second set of fins collectively define a second circumferential control surface extending around the tube wall and adapted to contact a target surface in place of a portion of the exterior surface from a plurality of radial positions around the tube wall;
the first circumferential control surface defines a first control surface diameter perpendicular to the axis of the tube wall;
the second circumferential control surface defines a second control surface diameter perpendicular to the axis of the tube wall; and
the first control surface diameter and the second control surface diameter each exceeds the exterior surface diameter by a variable amount based on how far the first set of fins and the second set of fins, respectively, protrude beyond the exterior surface of the tube wall.

6. The roller assembly of claim 5, wherein:
the control surface assembly includes a base member on which both the first set of fins and the second set of fins are pivotally mounted; and
the fin actuator is configured to selectively and independently pivot the first set of fins and the second set of fins between the retracted position and the extended position.

7. The roller assembly of claim 6, wherein the base member is located at an axial center of the tube wall within the interior space of the tube wall.

8. The roller assembly of claim 7, wherein:
the tube wall includes a first axial end and a second axial end opposite the first axial end;
the first set of fins extend from the base member towards the first axial end; and
the second set of fins extend from the base member towards the second axial end.

9. The roller assembly of claim 8, wherein:
the first set of slots are defined between the axial center of the tube wall and the first axial end of the tube wall; and
the second set of slots are defined between the axial center of the tube wall and the second axial end of the tube wall.

10. The roller assembly of claim 9, wherein the fin actuator includes:
a first cam configured to selectively pivot the first set of fins between the retracted position and the extended position; and
a second cam configured to selectively pivot the second set of fins between the retracted position and the extended position.

11. The roller assembly of claim 10, wherein:
the first cam is disposed between the axial center of the tube wall and the first axial end of the tube wall and operable to selectively move between the axial center of the tube wall and the first axial end of the tube wall to selectively to selectively pivot the first set of fins between the retracted position and the extended position; and
the second cam is disposed between the axial center of the tube wall and the second axial end of the tube wall and operable to selectively move between the axial center of the tube wall and the second axial end of the tube wall to selectively pivot the second set of fins between the retracted position and the extended position.

12. The roller assembly of claim 11, wherein the fin actuator includes:
a first linear actuator configured to axially translate the first cam between the first axial end and the axial center; and
a second linear actuator configured to axially translate the second cam between the second axial end and the axial center.

13. The roller assembly of claim 12, wherein:
the first linear actuator translating the first cam towards the base member at the axial center pivots the first set of fins between the retracted position and the extended position; and
the second linear actuator translating the second cam towards the base member at the axial center pivots the second set of fins between the retracted position and the extended position.

14. The roller assembly of claim 8, wherein portions of the first set of fins and the second set of fins are axially aligned and circumferentially spaced proximal to the axial center of the tube wall.

15. The roller assembly of claim 1, wherein:
the tube wall is drivingly coupled to a drive shaft of a vehicle;
the tube wall supports the vehicle from the ground, which defines the target surface; and
the tube wall propels the vehicle over the ground when driven by the drive shaft.

16. The roller assembly of claim 15, wherein the control surface assembly dynamically steers the vehicle by varying amounts based on how far the fins protrude beyond the exterior surface of the tube wall.

17. The roller assembly of claim 16, wherein:
the slots include:
a first set of slots circumferentially spaced around the tube wall at a first axial position along the tube wall; and
a second set of slots circumferentially spaced around the tube wall at a second axial position along the tube wall, the second axial position being axially offset from the first axial position; and
the fins include:
a first set of fins aligned with the first set of slots; and
a second set of fins aligned with the second set of slots.

18. The roller assembly of claim 17, wherein the fin actuator is configured to selectively and independently move the first set of fins and the second set of fins between the retracted position and the extended position.

19. The roller assembly of claim 18, wherein:
each fin in the first set of fins and the second set of fins includes a control surface configured to contact the target surface when the fins are selectively moved to protrude beyond the exterior surface of the roller;
the control surfaces of the first set of fins collectively define a first circumferential control surface extending around the tube wall and adapted to contact the target surface in place of a portion of the exterior surface from a plurality of radial positions around the tube wall;
the control surfaces of the second set of fins collectively define a second circumferential control surface extending around the tube wall and adapted to contact the target surface in place of a portion of the exterior surface from a plurality of radial positions around the tube wall;
the first circumferential control surface defines a first control surface diameter perpendicular to the axis of the tube wall;
the second circumferential control surface defines a second control surface diameter perpendicular to the axis of the tube wall; and
the first control surface diameter and the second control surface diameter each exceeds the exterior surface diameter by a variable amount based on how far the first set of fins and the second set of fins, respectively, protrude beyond the exterior surface of the tube wall.

20. The roller assembly of claim 19, wherein:
the control surface assembly includes a base member on which both the first set of fins and the second set of fins are pivotally mounted;
the fin actuator is configured to selectively and independently pivot the first set of fins and the second set of fins between the retracted position and the extended position;
the base member is located at an axial center of the tube wall within the interior space of the tube wall;
the tube wall includes a first axial end and a second axial end opposite the first axial end;
the first set of fins extend from the base member towards the first axial end;
the second set of fins extend from the base member towards the second axial end;
the control surface assembly dynamically steers the vehicle towards the second axial end by extending the first set of fins beyond the exterior surface of the tube wall; and
the control surface assembly dynamically steers the vehicle towards the first axial end by extending the second set of fins beyond the exterior surface of the tube wall.
